(19) United States
(12) Patent Application Publication
(10) Pub. No.: US 2026/0022280 A1
(43) Pub. Date: Jan. 22, 2026

(54) LOW VOC SOLVENT CEMENT FORMULATION WITH REDUCED TOXICITY AND RAPID CURING

(71) Applicants: Ranjith KOKKOT, Bangalore (IN); Ashirvad Pipes Pvt Ltd, Bengaluru (IN)

(72) Inventors: Ranjith KOKKOT, Bangalore (IN); Vignesh PAVUNRAJ, Usilampatti (IN); Babu MALLIKARCHUNAN, Thiruvallur (IN); Shireesh PANKAJ, Bangalore (IN); Chinmay Pradeep KULKARNI, Mumbai (IN)

(21) Appl. No.: 18/997,074

(22) PCT Filed: Jul. 17, 2023
(86) PCT No.: PCT/IN2023/050693

§ 371 Date: Jan. 18, 2025

(30) Foreign Application Priority Data
Jul. 18, 2022 (IN) 202241040959

(51) Int. Cl. C09J 127/24; C09J 11/04; C09J 11/06; C09J 11/08

(52) U.S. Cl. CPC C09J 127/24; C09J 11/04; C09J 11/06; C09J 11/08

(57) ABSTRACT

The present invention relates to a PVC/CPVC solvent cement formulations using less toxic ketonic solvent mixtures comprising of first three members in homologous series of ketones having one low boiling ketone with boiling point less than 70° C. and solvent mixture having two medium boiling ketones with boiling point around 100° C. The solvent cement formulation disclosed in the present invention is less toxic, low VOC and fast curing method of preparing said composition comprising PVC/CPVC solvent cement, which is less toxic, low VOC, fast curing and cost effective.

### FIELD OF INVENTION

The present invention in general relates to the polymer science. More particularly, the present invention relates to a solvent cement comprising aliphatic ketonic solvent mixture & organic heat stabilizers which is fast curing and less toxic.

### BACKGROUND OF INVENTION

In earlier days, people were using GI pipes for the transportation of water from one place to another. In such piping systems, pipes and fittings were jointed using mechanical locking with the use of thread in the pipes and fittings. Later, GI pipes were replaced by CPVC and PVC pipes as these pipes provide additional advantage of anti-corrosion and rust resistance apart from being light weight, and low cost. However, the jointing technology using mechanical locking is not possible in such cases as it is difficult to make thread in the moulding process.

In order to solve the problem, solvent cement jointing was introduced to join the pipes and fittings together in a simpler way. Briefly, solvent cement is made up of base resin, stabilizers and fillers dissolved in a mixture of solvents. Once applied to the material surface, the solvents soften and dissolve the top layer of material, essentially untangling the polymer chain. Then, as two pieces of materials are pressed together and as the solvent evaporates, the freed molecules of one-piece bond with the free molecules of the second piece. A tapered fitting ensures good contact between the outer wall of the pipe and the inner wall of the fitting. Then, the resin in the solvent cement fills in any gaps that exist between the two pieces, creating one continuous piece. It is notable that there is no chemical mechanism or reaction involved as it is a two-step process of dissolution of the substrate and proper filling of resin in gaps with the evaporation of the solvents.

Further, CPVC and PVC Solvent Cements are adhered to the ASTM standards such as ASTM F 493 & ASTM D 2564 respectively. The heterocyclic solvents such as Tetrahydrofuran and Alicyclic solvent such as Cyclohexanone are the most common solvents used in the solvent cements for PVC and CPVC. Their solubility parameter which is very much similar to that of PVC and CPVC resin makes them as a potential candidate for better dissolution during mixing step and also in application.

It has been reported extensively that most of the commercially available CPVC solvent cement at present consists of heterocyclic solvents such as tetrahydrofuran and alicyclic solvent such as cyclohexanone as major components in their formulation. However, this is also a proven fact that Tetrahydrofuran is highly toxic and harmful. As per European Chemical Agency, Tetrahydrofuran is classified as suspected to be Carcinogenic and there are chances to completely ban the use of tetrahydrofuran in the product which comes directly in contact with the food and drinking water applications as disclosed in the patent document EP2814893B1.

Also, there are several reports disclosing Cyclohexanone as an important component in the PVC/CPVC Solvent cement formulations because of their high boiling points which helps in maintaining the stability of the solvent cement over a period for longer shelf life. However, longer time duration is required to evaporate the high boiling solvent and which, in turn increases the time of proper joint as defined in the patent document CA2879347A1. Also, heat stabilizer systems used in the cited document are heavy metal based organotin compounds or lead compounds such Dibutyltin, Tributyltin, Dibasic lead sulphate, etc., which are harmful and may even cause death in humans and animals.

Nevertheless, there are several solvent cements based on Ca/Zn based stabilizers. However, very few have been reported to possess high thermal stability. Also, leaching of these heavy metals into the water can cause high potential threat to the human life and environment as disclosed in CN103183644A, US 2011/0129628A1, WO 2016/085785 A1.

Nonetheless, there is no disclosure in any of the prior art till date defining a solvent cement which is less toxic, low VOC and fast curing, free of any heterocyclic, alicyclic solvents, such as tetrahydrofuran and cyclohexanone.

Thus, there is an urgent need to develop a composition comprising PVC/CPVC solvent cement using aliphatic ketonic solvent mixture & organic heat stabilizer/co-stabilizer for better performance in terms of thermal stability, which is less toxic, low VOC, fast curing and cost effective.

### OBJECT OF THE INVENTION

An aspect of the present invention is to provide an improved and less toxic PVC/CPVC solvent cement formulation.

Another aspect of the present invention is to provide an improved and less toxic PVC/CPVC solvent cement formulation which is fast-curing and less harmful and toxic.

Another aspect of the present invention is to provide a novel and improved non-hazardous and fast curing product suitable for use in PVC/CPVC adhesives.

### SUMMARY OF THE INVENTION

According to an embodiment, the present invention discloses a composition comprising PVC/CPVC solvent cement using aliphatic ketonic solvent mixture & organic heat stabilizer, which is less toxic, low VOC, fast curing and cost effective.

In still another embodiment, the present invention provides a less toxic, low VOC and fast curing method of preparing said composition comprising PVC/CPVC solvent cement, which is less toxic, fast curing, low VOC and cost effective.

Embodiments of the present invention aim to provide the PVC/CPVC Solvent cement formulations for bonding articles comprising;
i. Organic solvents;
ii. CPVC/PVC resin
iii. Organic heat Stabilizers;
iv. Polymeric modifier
v. Rheology modifiers
vi. Inorganic fillers
vii. Antioxidants
viii. Pigments

wherein said organic solvents are selected from, but not limited to ketonic, non-ketonic or mixture of Ketonic/non-ketonic solvents;

wherein said organic heat stabilizers are selected from, but not limited to, Uracil-based, Stearoyl Benzoyl Methane (SBM), another organic compound without any heavy metals;

wherein said solvent does not comprise Tetrahydrofuran (THF) and Cyclohexanone;

wherein said polymer modifier is selected from acrylic resin having molecular weight ranging from 50,000 g/mol to 10.00,000 g/mol;

wherein said rheology modifier is selected from chlorosilane treated fumed silica;

wherein said antioxidants are selected from butylene oxide and its derivatives;

wherein said pigments are selected from organic di-arylide azo compound.

It is to be understood that both the foregoing general description and the following detailed description are exemplary and explanatory only and are not restrictive of the invention, as claimed.

### BRIEF DESCRIPTION OF THE DRAWINGS

The manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally 5 effective embodiments.

These and other features, benefits, and advantages of the present invention will become apparent by reference to the following figures, wherein:

FIG. 1 illustrates a graph disclosing the development of strength of solvent cement formulation,

FIG. 2 illustrates the viscosity stability of the solvent cement formulation.

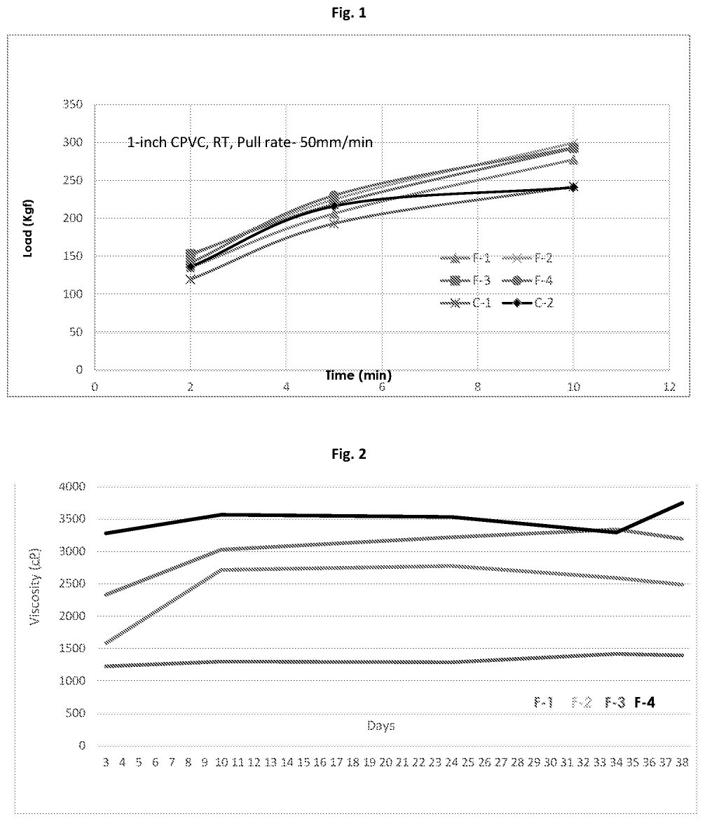

### DETAILED DESCRIPTION

The embodiments of the present invention disclose a composition comprising PVC/CPVC solvent cement using aliphatic ketonic solvent mixture & organic heat stabilizer, which is less toxic, low VOC, fast curing and cost effective.

Embodiments of the present invention aim to provide the PVC/CPVC Solvent cement formulations using less toxic ketonic solvent mixtures comprising of first three members in homologous series of ketones having one low boiling ketone with boiling point less than 70° C. and solvent mixture having two medium boiling ketones with boiling point around 100° C., wherein;
Low boiling ketonic solvent and medium boiling ketonic solvent mixture are in the ratio of 1:3;
Low boiling ketone is 2-Propanone or Acetone (ACE) with wt. % ranging from 20 to 30;
Medium boiling ketonic solvent mixture consists of wt. % ranging from 60 to 90;
2-Butanone or Methyl Ethyl Ketone (MEK);
2-Pentanone or Methyl Propyl Ketone (MPK);
Medium boiling ketonic solvent mixture used in the solvent system consists of 2-Butanone or Methyl Ethyl Ketone (MEK) and 2-Pentanone or Methyl Propyl Ketone (MPK) in the ratio of 3:1;
In medium boiling ketonic solvent mixture, 2-Butanone or Methyl Ethyl Ketone (MEK) wt. % ranges from 50 to 60;
In medium boiling ketonic solvent mixture, 2-Pentanone or Methyl Propyl Ketone (MPK) wt. % ranges from 15 to 20;
PVC/CPVC Solvent cement formulations using 6-amino-1 3-dimethyluracil as a heavy metal free Organic heat stabilizer in the wt % ranging from 1 to 5;

In yet another embodiment present invention discloses a PVC/CPVC Solvent cement formulations for bonding articles comprising;
ix. Organic solvents;
x. CPVC/PVC resin
xi. Organic heat Stabilizers;
xii. Polymeric modifier
xiii. Rheology modifiers
xiv. Inorganic fillers
xv. Antioxidants
xvi. Pigments

wherein said organic solvents are selected from, but not limited to ketonic, non-ketonic or mixture of Ketonic/non-ketonic solvents;

wherein said organic heat stabilizers are selected from, but not limited to, Uracil-based, Stearoyl Benzoyl Methane (SBM), another organic compound without any heavy metals;

wherein said solvent does not comprise Tetrahydrofuran (THF) and Cyclohexanone;

wherein said polymer modifier is selected from acrylic resin having molecular weight ranging from 50,000 g/mol to 10.00,000 g/mol;

wherein said rheology modifier is selected from chlorosilane treated fumed silica.

wherein said antioxidants are selected from butylene oxide and its derivatives' wherein said pigments are selected from organic diarylide azo compound.

In yet another embodiment, said ketones are selected from the first three members in homologous series of ketones having the boiling point less than 70° C. and wherein, the solvent mixture is having two medium boiling ketones with boiling point of 100° C.

In still another embodiment, the Low boiling ketonic solvent and solvent mixture is in the ratio of 1:3.

In yet another embodiment, the low boiling ketone is 2-Propanone or Acetone (ACE) with wt. % ratio ranging from 20 to 30.

In still another embodiment, the medium boiling ketonic solvent mixture is 2-Butanone or Methyl Ethyl Ketone (MEK) wt. % ranges from 50 to 60.
In still another embodiment, said medium boiling ketonic solvent mixture is 2-Pentanone or Methyl Propyl Ketone (MPK) wt % ranges from 15 to 20.
In yet another embodiment, said heat stabilizers are selected from 6-amino-1 3-dimethyl uracil and Stearoyl benzoyl methane in the wt % ranging from 0.5 to 5; and wherein said organic heat stabilizer is free from heavy metal and the compound.
In still another embodiment, the viscosity of said solvent cement formulation is 500-8000 cP at 25° C.
In still another embodiment, the pull of adhesion strength of said solvent cement formulation is 135 to 153 Kilogram force (Kgf) in 2 min., 5 mins. is 206 to 230 Kgf and 10 mins 277 to 300 Kgf respectively.
In yet another, the solvent cement formulation comprises volatile organic compounds <400 g/L as per SCAQMD 316A guidelines.
In still another embodiment, the K value of the CPVC resin is 57.
In yet another embodiment, the shelf life of said solvent cement is 24 months at 25° C.
In still another embodiment, the curing time or/and drying time of said solvent cement formulation ranges from 2 hours to 24 hours.
In yet another embodiment, the pressure withstanding capability of said solvent cement formulation ranges from 40 bars to 90 bars at the temperature ranging from 25° C. to 82° C. tested as per ASTM F 493.
In still another embodiment, said solvent cement formulation is a less toxic, low VOC and fast curing, free of any heterocyclic, alicyclic solvents, including tetrahydrofuran and cyclohexanone. It is also interesting to note that the performance of said solvent cement formulation is retained even after accelerated ageing done at 50° C. for one month duration.

It is worth notable that the present invention does not contain any heavy metal in the formulation. Also, there is no presence of banned, restricted or suspected list of solvents as referred by ECHA in the solvent system (in particular, THF and CYH). The present system has the efficiency for faster curing with less drying time. Most importantly, the formulation is safe to use for drinking water application as it complies to the migration test as per NSF 61 Section 6 guidelines.

The compositions of the present invention are easy to use on the PVC/CPVC surfaces with the fast-curing properties without the use of heat, UV light or extraordinary mechanical devices. The bonding or adhesive properties of said composition are non-hazardous and less toxic with low VOC content as measured according to South Coast Air Quality Management District (SCAQMD) 316A guidelines. Nevertheless, said compositions is a one-component system and hence easy to use and user friendly.

It is interesting to note that the composition of the present invention does not comprise banned or toxic solvents neither any heterocyclic solvents. Also, the disclosed composition consists of metal free organic heat stabilizer system which is non-toxic and exhibits improved strength in comparison with the conventional solvent cement because of the proper selection of solvent system with low boiling points and high solvency power for chlorinated resins.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### EXAMPLE

### Materials

### Physical Properties of the Solvents

| | | | | | Vapour | |
|---|---|---|---|---|---|---|
| | | | | | Pressure | |
| S. | Solvent | | Boiling | | (Mm Hg at | |
| No | System | Solvents | Point | | 20° C.) | Density |
| 1 | Novel | ACE | 56° | C. | 180 | 0.78 g/cc |
| 2 | Solvent | MEK | 102° | C. | 15 | 0.80 g/cc |
| 3 | System | MPK | 102° | C. | 12 | 0.80 g/cc |
| 4 | Conventional | THF | 66° | C. | 145 | 0.88 g/cc |
| 5 | solvent | CYH | 156° | C. | 3.75 | 0.95 g/cc |
| | system | | | | | |

### Solvents—ECHA Regulations

| S. | Solvent | | |
|---|---|---|---|
| No | System | Solvents | Hazard Classification & labelling |
| 1 | Novel | ACE | Danger! According to the harmonised |
| | Solvent | | classification and labelling (CLP00) |
| | System | | approved by the European Union, this |
| | | | substance is a highly flammable liquid and |
| | | | vapour, causes serious eye irritation and |
| | | | may cause drowsiness or dizziness. |
| 2 | | MEK | Danger! According to the harmonised |
| | | | classification and labelling (CLP00) |
| | | | approved by the European Union, this |
| | | | substance is a highly flammable liquid and |
| | | | vapour, causes serious eye irritation and |
| | | | may cause drowsiness or dizziness. |
| 3 | | MPK | Danger! According to the classification |
| | | | provided by companies to ECHA |
| | | | in REACH registrations this substance is a |
| | | | highly flammable liquid and vapour, is |
| | | | harmful if swallowed and causes serious |
| | | | eye irritation. |
| 4 | Conven- | THF | Danger! According to the harmonised |
| | tional | | classification and labelling (ATP03) |
| | solvent | | approved by the European Union, this |
| | system | | substance is a highly flammable liquid and |
| | | | vapour, causes serious eye irritation, is |
| | | | suspected of causing cancer and may cause |
| | | | respiratory irritation. |
| | | | Additionally, the classification provided by |
| | | | companies to ECHA in REACH |
| | | | registrations identifies that this substance is |
| | | | harmful if swallowed. |
| 5 | | CYH | Warning! According to the harmonised |
| | | | classification and labelling (CLP00) |
| | | | approved by the European Union, this |
| | | | substance is a flammable liquid and vapour |
| | | | and is harmful if inhaled. |
| | | | Additionally, the classification provided by |
| | | | companies to ECHA in REACH |
| | | | registrations identifies that this substance is |
| | | | harmful if swallowed, is harmful in contact |
| | | | with skin, causes serious eye damage, |
| | | | causes skin irritation and may cause |
| | | | respiratory irritation. |

### Solubility Parameter—Solvents

| | Solvent | | SPₒ | SP_{d} | SPₚ | SPₕ |
|---|---|---|---|---|---|---|
| S. | System/ | Solvents/ | (Total) | (Dispersion) | (Polar) | (H Bonding) |
| No | Resin | Resin | (Cal/cm³)^{1/2} | (Cal/cm³)^{1/2} | (Cal/cm³)^{1/2} | (Cal/cm³)^{1/2} |
| 1 | Novel Solvent | ACE | 9.8 | 7.6 | 5.1 | 3.4 |
| 2 | System | MEK | 9.3 | 7.8 | 4.4 | 2.5 |
| 3 | | MPK | 9.6 | 7.7 | 4.4 | 3.7 |
| 4 | Conventional | THF | 9.5 | 8.2 | 2.8 | 3.9 |
| 5 | solvent system | CYH | 9.6 | 8.7 | 3.1 | 2.5 |
| 6 | PVC Resin | PVC Resin | 10.3 | 9.0 | 4.3 | 2.8 |

Methods: Three different processes have been used to prepare the formulation.

### Process-1

1. MEK, MPK and Acetone was taken in a closed airtight mixer with stirrer and charged using PMMA (MW40,000 to 1,10,000) in the mixer.
2. The mixture was mixed with stirrer at RPM: 400 to 4000 for 10 to 20 mins.
3. The mixture obtained was charged as CPVC resin and pigment and mixed for 150 mins to 250 mins continuously.
4. After that add viscosity modifiers, stabilizers antioxidants and continue mixing for 50 to 100 mins.
5. Maintain constant temperature between 25 to 32° C. throughout the process using water.

### Process-2

1. MEK, MPK and Acetone was collected in a closed airtight mixer with stirrer and charged PMMA (MW40,000 to 1,10,000) in the mixer.
2. The above mixture was mixed with stirrer at RPM: 400 to 4000 continuously for 10 to 20 mins.
3. CPVC resin and pigment was charged in the mixture continuously for 150 mins to 250 mins.
4. Viscosity modifiers, stabilizers, antioxidants were mixed with the above mixture by continuous stirring for 50 to 100 mins.
5. The temperature was maintained between 32 to 38° C. throughout the process using water.

### Process-3

This process is the most suitable process and results into the most desired results.
1. MEK, MPK and Acetone was mixed in a closed airtight mixer with stirrer and charge PMMA (MW40,000 to 1,10,000) in the mixer.
2. Above mixture was mixed with stirrer at RPM: 400 to 4000 for 10 to 35 mins.
3. A viscosity-modifiers, stabilizers and continue mixing for 5 to 20 mins.
4. Charge CPVC resin and pigment in the mixture and continued mixing for 150 mins to 250 mins.
5. Antioxidants were added in the above mixture by continuously mixing for 5 to 20 mins.
6. A constant temperature between 25 to 30° C. was maintained throughout the process using water.

### Solvent Selection Criteria

| | | | Boiling | | |
|---|---|---|---|---|---|
| S. | | ECHA | Point | Vapour Pressure | |
| No | Solvents Name | Concern | (° C.) | (mm Hg at 20° C.) | |
| 1 | Dimethyl adipate | No | 227 | 0.06 | |
| 2 | N-Methyl-2-Pyrrolidone | Yes | 202 | 0.29 | |
| 3 | Dimethyl sulfoxide | No | 189 | 0.44 | |
| 4 | γ-Butyrolactone | No | 204 | 1.12 | |
| 5 | Methyl amyl ketone | No | 151 | 1.5 | |
| 6 | Di isobutyl ketone | No | 168 | 1.72 | |
| 7 | Ethyl amyl ketone | No | 168 | 2 | |
| 8 | Acetylacetone | No | 140 | 2.96 | |
| 9 | Dimethylformamide | Yes | 153 | 3.67 | |
| 10 | Cyclohexanone | No | 156 | 3.75 | |
| 11 | Methyl iso amyl ketone | Yes | 144 | 4.5 | |
| 12 | 1,2 Diethoxy ethane | Yes | 121 | 9 | |
| 13 | N-butyl acetate | No | 126 | 9 | |
| 14 | Cyclopentanone | No | 131 | 11.4 | |
| 15 | Methyl propyl ketone | No | 102 | 12 | |
| 16 | Diethyl ketone | No | 102 | 15 | |
| 17 | Methyl Ethyl Ketone | No | 102 | 15 | |
| 18 | 1,1 Diethoxy ethane | Yes | 103 | 20.25 | |
| 19 | Methyl iso propyl ketone | No | 94 | 41.25 | |
| 20 | Ethanol | Yes | 78 | 43.5 | |
| 21 | Ethyl acetate | No | 77 | 75 | |
| 22 | Methanol | Yes | 65 | 96.75 | |
| 23 | 2-Methyl tetrahydrofuran | No | 80 | 102 | |
| 24 | Tetrahydrofuran | Yes | 66 | 144.76 | |
| 25 | N-methylacetate | Yes | 57 | 173 | |
| 26 | Acetone | No | 56 | 180 | |
| 27 | Cyclopentyl Methyl Ether | No | 106 | 44.92 | (25° C.) |
| 28 | t-butyl acetate | No | 97 | 47.25 | (25° C.) |
| 29 | Dimethyl Carbonate | No | 90 | 55.5 | (25° C.) |

| | | | | |
|---|---|---|---|---|
| 30 | Dimethyl-2-piperidone | No | NA | NA |
| 31 | N-ethyl caprolactam | No | NA | NA |

| | | CAS | | Classification CLP | Properties | Acute |
|---|---|---|---|---|---|---|
| Solvents | | No | | Regulation | of Concern | toxicity |
| Solvents | Cyclohexanone | 108- | [symbol] | Danger! Hazardous | Under | LD50 Oral = |
| in | | 94-1 | | Flammable liquids | regulatory | 1544 mg/kg |
| Existing | | | | (Category 3), H226 | concerns | (Rat) |
| System | | | | Acute toxicity, Oral | in EU | LD50 |
| | | | | (Category 4), H302 | | Dermal = |
| | | | | Acute toxicity, | | 947 mg/kg |
| | | | | Inhalation | | (Rabbit) |
| | | | | (Category 4), H332 | | LD50 |
| | | | | Acute toxicity, Dermal | | Inhalation = |
| | | | | (Category 4), H312 | | 8000 ppm |
| | | | | Skin irritation | | (Rat ) 4 h |
| | | | | (Category 2), H315 | | |
| | | | | Serious eye damage | | |
| | | | | (Category 1), H318 | | |
| | THF | 109- | [symbol] | Danger! Health hazard | Carcinogenicity | LD50- Oral- |
| | | 99-9 | | Flammable liquids | | Rat-male |
| | | | | (Category 2), H225 | | and female- |
| | | | | Acute toxicity, Oral | | 1.650 mg/kg |
| | | | | (Category 4), H302 | | LC50- |
| | | | | Eye irritation | | Inhalation- |
| | | | | (Category 2), H319 | | Rat-male |
| | | | | Carcinogenicity | | and female- |
| | | | | (Category 2), H351 | | 4 h −> 16.9 |
| | | | | Specific target organ | | mg/l LD50- |
| | | | | toxicity - single | | Dermal-Rat- |
| | | | | exposure (Category 3), | | male and |
| | | | | Central nervous system, | | female −> |
| | | | | H336 | | 2.000 mg/kg |
| | | | | Specific target organ | | No toxicity |
| | | | | toxicity - single | | to |
| | | | | exposure (Category 3), | | reproduction |
| | | | | Respiratory system, H335 | | |
| | 1,3 | 646- | [symbol] | Danger Highly | Reprotoxic | LD50 Oral - |
| | Dioxolane | 06-0 | | flammable liquid | | Rat - male |
| | | | | and vapor. H225 | | and female - |
| | | | | Causes serious eye | | 5.200 mg/kg |
| | | | | damage. H318 | | LC50 |
| | | | | May damage fertility or | | Inhalation - |
| | | | | the unborn child H360 | | Rat - male |
| | | | | | | and female - |
| | | | | | | 4 h - 68, |
| | | | | | | 4 mg/l |
| | | | | | | LD50 |
| | | | | | | Dermal - |
| | | | | | | Rat - 15.000 |
| | | | | | | mg/kg |
| Solvents | Methyl | 78-93- | [symbol] | Danger! Flammable | NA | LD50 Oral- |
| in | ethyl | 3 | | liquids Category 2), | | Rat-male |
| current | ketone | | | (H225 Eye irritation | | and female- |
| invention | | | | (Category 2), H319 | | 2.193 mg/kg |
| | | | | Specific target organ | | LC50 |
| | | | | toxicity - single | | Inhalation- |
| | | | | exposure (Category 3), | | Mouse-4 h- |
| | | | | Central nervous system, | | 32.000 mg/m3 |
| | | | | H336 | | LD50 |
| | | | | | | Dermal- |
| | | | | | | Rabbit- |
| | | | | | | 6.480 mg/kg |
| | | | | | | Not |
| | | | | | | reprotoxic |
| | | | | | | and |
| | | | | | | carcinogenic |
| | Acetone | 67-64- | [symbol] | Warning! Flammable | NA | LD50 Oral- |
| | | 1 | | liquid, Category 3, | | Rat: 3.200 |
| | | | | H226 Acute toxicity, | | mg/kg |
| | | | | Category 4, Inhalation, | | LD50 Dermal |
| | | | | H332 | | Rabbit: |
| | | | | | | 8.100 mg/kg |
| | Methyl | 107- | [symbol] | Danger! According to | NA | LD50 |
| | Propyl | 87-9 | | the classification | | OralRat- |
| | ketone | | | provided by companies | | female −> |
| | | | | to ECHA in REACH | | 16000 mg/kg |
| | | | | registrations. | | LC50 |
| | | | | Highly flammable | | Inhalation- |
| | | | | (Category 2) | | Rat-4 h- |
| | | | | Acute toxicity Oral | | 25.5 mg/1 |
| | | | | (Category 4) | | LD50 |
| | | | | Serious eye damage/eye | | Dermal-Rat- |
| | | | | irritation (Category 2) | | male and |
| | | | | | | female −> |
| | | | | | | 6480 mg/kg |

| S. | | | Boiling | | Vapour Pressure | | SPₒ (Total) |
|---|---|---|---|---|---|---|---|
| No | Solvent System | Solvents | Point | | (mm Hg at 20° C.) | Density | (Cal/cm³)^{1/2} |
| 1 | Novel | ACE | 56° | C. | 180 | 0.78 g/cc | 9.8 |
| 2 | Solvent | MEK | 102° | C. | 15 | 0.80 g/cc | 9.3 |
| 3 | System | MPK | 102° | C. | 12 | 0.80 g/cc | 9.6 |
| 4 | Conventional | THF | 66° | C. | 145 | 0.88 g/cc | 9.5 |
| 5 | solvent system | CYH | 156° | C. | 3.75 | 0 95 g/cc | 9.6 |

| | 6-amino-1,3- | Stearoyl |
|---|---|---|
| | dimethyl | Benzoyl |
| Methyl Tin mercaptide | Uracil | Methane |
| CAS number: 57583-35-4 | CAS number: | CAS number: |
| | 6642-31-5 | 58446-52-9 |
| 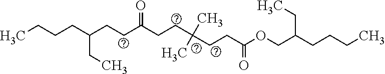 [SMILES: CCCCC(CC)CCC(=O)CCC(C)(C)CCC(=O)OCC(CC)CCCC] | 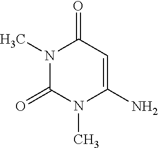 | 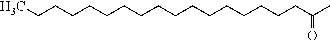 [SMILES: CCCCCCCCCCCCCCCCCC(C)=O] |
| EC number: 260-829-0 | EC number: | EC number: |
| | 229-662-0 | 261-257-4 |
| [symbol] | Not Applicable | Not Applicable |
| Danger! According to the harmonised classification and | No hazards have | No hazards have |
| labelling (ATP06) approved by the European Union, this | been classified | been classified |
| substance causes damage to organs through prolonged or | | |
| repeated exposure, is harmful if swallowed, is suspected of | | |
| damaging the unborn child and may cause an allergic skin | | |
| reaction. | | |
| Additionally, the classification provided by companies to | | |
| ECHA in REACH registrations identifies that this substance | | |
| is suspected of damaging fertility or the unborn child, is | | |
| harmful in contact with skin and is harmful to aquatic life | | |
| with long lasting effects. | | |
| At least one company has indicated that the substance | | |
| classification is affected by impurities or additives. | | |

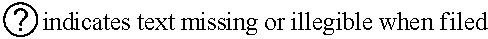

### Screened Formulations

| Ingredients | F-1 | F-2 | F-3 | F-4 |
|---|---|---|---|---|
| Methyl Propyl Ketone | 8-15 | 8-15 | 10-20 | 10-20 |
| Acetone | 18-25 | 18-25 | 12-20 | 5-10 |
| Methyl Ethyl Ketone | 20-45 | 20-45 | 20-45 | 40-65 |
| CPVC/PVC Resin (K 57) | 0.00 | 0.00 | 5-15 | 5-15 |
| CPVC/PVC Resin (K 67) | 5-15 | 5-15 | 0.00 | 0.00 |
| Impact modifer | 2.95 | 2.93 | 0.00 | 0.00 |
| Orange pigment | 0.00 | 0.00 | 0.00 | 0.00 |
| Yellow pigment | 0.02 | 0.02 | 0.05 | 0.05 |
| Titanium dioxide | 0.08 | 0.08 | 0.00 | 0.00 |
| Acrylic resin low Mol wt | 0.00 | 0.00 | 0.00 | 2-10 |
| Acrylic resin high Mol. wt | 0.5-1 | 0.5-1 | 0.5-1 | 0.00 |
| Fumed Silica | 0.00 | 0.00 | 0.1-0.5 | 0.1-0.5 |
| Precipitated Silica | 0.5-1 | 1.01 | 1.01 | 0.00 |
| Methyl Tin mercaptide | 0.14 | 0.00 | 0.00 | 0.00 |
| 6 amino 1,3 dimethyl Uracil | 0.00 | 0.5-1.5 | 0.5-1.5 | 0.00 |
| Stearoyl Benzoyl Methane | 0.00 | 0.00 | 0.00 | 0.5-1.5 |
| Antioxidant | 0.5-0.8 | 0.5-0.8 | 0.5-0.8 | 0.5-0.8 |

### Test Data of Screened Formulations:

| | | | | | | | | C-1 (THF | | C-2 (1,3 | |
|---|---|---|---|---|---|---|---|---|---|---|---|
| | Test | | | | | | | and CYH | | Dioxolane | |
| Properties | Conditions | F-1 | | F-2 | | F-3 | F-4 | based) | | based) | |
| Density | ASTM D2693, | 0.88 | g/cc | 0.86 | g/cc | 0.87 g/cc | 0.89 g/cc | 10.96 | g/cc | 0.98 | g/cc |
| | 23° C. | | | | | | | | | | |
| Solid content | ASTM D 1475, | 17.82% | | 17.01% | | 18.5% | 21.5% | 22.68% | | TBD | |
| | 110° C., 1 hr | | | | | | | | | | |
| Viscosity | ASTM 1084, | 1400 ± 100 | cP | 1460 | cp | 2600 | 3672 | 2533 | cp | 46020 | cP |

| | | | | | | | |
|---|---|---|---|---|---|---|---|
| | at 23 ± 2° C. | | | | | | |
| Pull out - 2 | 1 -inch | 135.4 ± 10.1 | 151.0 ± 2.3 | 153.1 ± 2 | 141.23 ± 4.2 | 119.53 ± 8.5 | 136.0 ± 13.6 |
| minutes (Kgf) | CPVC, RT, | | | | | | |
| Pull out - 5 | Pull rate- | 206.27 ± 3.0 | 224.9 ± 7.6 | 218.8 ± 1.5 | 230.2 ± 3.3 | 193.13 ± 16.4 | 216.1 ± 3.4 |
| minutes (Kgf)) | 50 mm/min | | | | | | |
| Pull out - 10 | | 277.43 ± 20.7 | 299.5 ± 4.8 | 292.3 ± 2.4 | 293.4 ± 5.3 | 241.88 ± 12 | 240.67 ± 12.5 |
| minutes (Kgf)) | | | | | | | |
| Burst | At 25 C. | No of | No of | Sample 1: | Sample 1: | No of | No of |
| Pressure test | 2-inch SDR | specimens | specimens | 87.3 bar, | 85.3 bar, | specimens | specimens |
| (ASTM F 493) | 11 pipes - | tested-2 | tested-3 | specimen | specimen | tested-3 | tested-3 |
| | 150 mm | Result- Passed | Result- | failure | failure | Result- | Result- |
| | length, 6 | Failure | Passed | Sample 2: | Sample 2: | Passed | Passed |
| | nominal | pressure - | Failure | 91.3 bar, | 88.3 bar, | Failure | Failure |
| | joints | 61.31 bar, | pressure- | specimen | specimen | pressure - | pressure- |
| | 2 hours | 60.21 bar | 68.6 bar, | failure | failure | 64.2 bar, | 76.3 bar, |
| | drying, | (Substrate | 71.5 bar, | | | (Substrate | 79.1 bar, |
| | Pressure | failure) | 73.2 bar | | | failure) | 75.7 bar |
| | increased | | (substrate | | | 48 bar, | (Substrate |
| | up to 27.6 | | failure at | | | 51.5 bar | failure at |
| | bar within | | bend) | | | (Joint | bend |
| | 60 to 70 sec | | | | | removed | |
| | At 82 C. | No of | No of | Sample 1: | Sample 1: | No of | No of |
| | 2 inch SDR | specimens | specimens | 46.6 bar, | 44.7 bar, | specimens | specimens |
| | 11 pipes - | tested-3 | tested-3 | Bond | Joint | tested-1 | tested-3 |
| | 150 mm | Result- | Result- | failure | removed | Result- | Result- |
| | length, 6 | Passed | Passed | Sample 2: | Sample 2: | Passed | Passed |
| | nominal | Failure | Failure | 52.8 bar, | 50.2 bar, | Failure | Failure |
| | joints | pressure- | pressure- | Bond | joint | pressure - | pressure- |
| | 2 hours | 58.2 bar, | 58.1 bar, | failure | removed | 53.2 bar, | 51.3 bar, |
| | drying, at | 55.1 bar (SF), | 49.0 bar (2 | | | (Joint | 63.6 bar (2 |
| | 82 C., | 56.7 bar | specimens) | | | removed) | specimens) |
| | Pressure | (Joint | 69.1 bar | | | | 82.5 bar |
| | increased | removed) | (substrate | | | | (substrate |
| | upto 13.8 | | failure at | | | | failure at |
| | bar within | | bend) | | | | bend) |
| | 60 to 70 sec | | | | | | |

### VOC

| Properties | Test Method | F-1 | F-2 | F-3 | F-4 | C-1 | C-2 |
|---|---|---|---|---|---|---|---|
| VOC | (SCAQMD 316A-92) | 469 g/1 | 468 g/1 | 392 g/1 | 389 g/1 | 570 g/1 | 707 g/1 |

### Ring Shear Strength

| Standard | EN 14814, Section 4.2 | |
|---|---|---|
| Requirement | ISO 9311-2 | |
| as per | ● | Assembling of 40 mm dia pipe and straight socket coupling by |
| Standard | | Remove any swarf and other debris from the joining surfaces of |
| | | the fitting and pipe. |
| | ● | Dry the solvent cement joints in air at 23° C. for 1 hrs, 24 hrs and |
| | | 480 hrs.(20 days) + 80° C. for 96 hrs.(4 days) |
| | ● | Prepare specimens of 10 mm thick rings from bonded area using |
| | | lathe machine |
| | ● | Test shear strength using UTM compression mode at the rate of |
| | | 5 mm/min |
| | ● | Record shear strength at specified drying time intervals |
| | ● | Requirement |
| | 1 hr curing at RT - 0.4 MPa | |
| | 24 hrs curing at RT - 1.5 MPa | |
| | 480 hrs at RT + 96 hrs 80° C.-10 MPa | |
| Test results (F-2) | F-2 | |
| | ● | 1 hrs curing at RT - 4.52 ± 0.78 MPa |
| | ● | 24 hrs curing at RT - 7.55 ± 0.85 MPa |
| | ● | 480 hrs at RT + 96 hrs at 80° C. - 13.3 ± 1.5 Mpa |

### ADVANTAGES OF THE INVENTION

Solvent system does not comprise of banned or toxic solvents.
Solvent system does not contain any heterocyclic solvents.
Metal free organic heat stabilizer system which is non-toxic.
VOC is within the limit as mentioned by SCAQMD—rule 1168.
Fast curing with less drying time as there are no high boiling solvents present in the system.
safe to use for drinking water application as it complies to the migration test as per NSF 61 Section 6 guidelines.
The pressure withstanding capability is high in terms of both hot and cold-water applications.
Handling strength is achieved in short period of time.
Free from pungent ethereal smell as only ketonic solvents are used in the system.
Density is less compared to the conventional solvent cement.
High temperature stability and Room temperature stability is better even without the use of high boiling solvents in the system.
No deterioration in the performance properties even after heat ageing @49° C. for 30 days.
Development of strength is good in comparison with the conventional solvent cement because of the proper selection of solvent system with low boiling points and high solvency power for chlorinated resins.

We claim;:

1. A CPVC/PVC solvent cement formulation for bonding articles comprising;
i. Organic solvents;
ii. CPVC/PVC resin
iii. Organic heat Stabilizers;
iv. Polymeric modifier
v. Rheology modifiers
vi. Inorganic fillers
vii. Antioxidant
viii. Pigments
wherein said organic solvents are selected from, but not limited to ketonic, non-ketonic or mixture of Ketonic/non-ketonic solvents;
wherein said organic heat stabilizers are selected from, but not limited to, Uracil-based, Stearoyl Benzoyl Methane (SBM), another organic compound without any heavy metals;
wherein said solvent does not comprise Tetrahydrofuran (THF) and Cyclohexanone;
wherein said polymer modifier is selected from acrylic resin having molecular weight ranging from 50,000 g/mol to 10.00,000 g.mol.
wherein said rheology modifier is selected from chlorosilane treated fumed silica.
wherein said antioxidant is selected from butylene oxide and its derivatives.
wherein said pigments are selected from organic diarylike azo compound.

2. The solvent cement formulation as claimed in claim 1, wherein the ketones are selected from the first three members in homologous series of ketones having the boiling point less than 70° C. and wherein, the solvent mixture is having two medium boiling ketones with boiling point of 100° C.

3. The solvent cement formulation as claimed in claim 1, wherein the low boiling ketonic solvent and solvent mixture in said cement solvent formulation is in the ratio of 1:3.

4. The solvent cement formulation as claimed in claim 1, wherein low boiling ketone is 2-Propanone or Acetone (ACE) with wt. % ratio ranging from 20 to 30.

5. The solvent cement formulation as claimed in claim 1, wherein medium boiling ketonic solvent mixture is 2-Butanone or Methyl Ethyl Ketone (MEK) wt. % ranges from 50 to 60.

6. The solvent cement formulation as claimed in claim 1, wherein medium boiling ketonic solvent mixture is 2-Pentanone or Methyl Propyl Ketone (MPK) wt. % ranges from 15 to 20.

7. The solvent cement formulation as claimed in claim 1, wherein said heat stabilizers are selected from 6-amino-1 3-dimethyl uracil and stearoyl benzoyl methane in the wt. % ranging from 0.5 to 5; and wherein said organic heat stabilizer is free from heavy metal and the compound.

8. The solvent cement formulations as claimed in claim 1, wherein the viscosity of said solvent cement formulation is 500-8000 cP at 25° C.

9. The solvent cement formulation as claimed in claim 1, wherein the pull of adhesion strength of said solvent cement formulation is 135 to 153 Kilogram force (Kgf) in 2 to 5 mins. is 206 to 230 Kgf and in 10 mins is 277 to 300 Kgf.

10. The solvent cement formulation claimed in claim 1, wherein said volatile organic compounds are <400 g/L as per SCAQMD 316A guidelines.

11. The solvent cement formulation as claimed in claim 1, wherein the K value of the CPVC resin is said cement solvent is 57.

12. The solvent cement formulation as claimed in claim 1, wherein the shelf life of said solvent cement is 24 months to 36 months at 25° C.

13. The solvent cement formulation as claimed in claim 1, wherein the curing time or/and drying time of said solvent cement formulation ranges from 2 hours to 24 hours.

14. The solvent cement formulation as claimed in claim 1, wherein the pressure withstanding capability of said solvent ranges from 40 bar to 90 bar at the temperature ranging from 25° C. to 82° C. tested as per ASTM F 493.

15. The solvent cement claimed in claim 1, wherein said solvent cement formulation is a less toxic, low VOC and fast curing, free of any heterocyclic, alicyclic solvents, including tetrahydrofuran and cyclohexanone.
